(19) United States
(12) Patent Application Publication
(10) Pub. No.: US 2023/0137706 A1
(43) Pub. Date: May 4, 2023

(54) DISTANCE MEASURING APPARATUS, DISTANCE MEASURING PROGRAM

(71) Applicant: Hitachi-LG Data Storage, Inc., Tokyo (JP)

(72) Inventor: Koichi Sakita, Tokyo (JP)

(73) Assignee: Hitachi-LG Data Storage, Inc., Tokyo (JP)

(21) Appl. No.: 17/943,306

(22) Filed: Sep. 13, 2022

(30) Foreign Application Priority Data
Nov. 4, 2021 (JP) 2021-180170

(51) Int. Cl. G01S 7/4865; G01S 17/10; G01S 17/89; G01S 7/497

(52) U.S. Cl. CPC G01S 7/4865; G01S 17/10; G01S 17/89; G01S 7/497

(57) ABSTRACT

An objective of the present disclosure is to easily and precisely correct a distance error caused by multipath phenomenon in a distance measuring apparatus using TOF method. A distance measuring apparatus according to the present disclosure identifies an equation of plane that approximates a plane in a space where a target object exists, compares the equation of plane with a measured distance of the place, thereby calculating a correcting value for correcting a measured distance.

### CROSS-REFERENCE TO RELATED APPLICATION

This application claims the priority of Japanese Patent Application No. 2021-180170 filed on Nov. 4, 2021, which is incorporated herein by reference in its entirety.

### BACKGROUND OF THE DISCLOSURE

### 1. Field of the Disclosure

The present disclosure relates to a distance measuring apparatus for measuring a distance to a target object.

### 2. Description of the Related Art

Distance measuring device (hereinafter, also referred to as TOF device) is commonly known which measures a distance to a target object according to time of flight of light (hereinafter, referred to as TOF method). Distance data measured by TOF device is displayed as a two-dimensional distance image, and temporal variations of the distance image are tracked, thereby being capable of calculating a moving path (flow line) of a person within a room, for example.

The TOF device measures a duration (optical path length) from when irradiated light is emitted from a light source, which is reflected at a target object, to when the reflected light returns to an optical receiver. The TOF device thereby calculates a distance to the target object. Accordingly, when using the TOF device under an environment where highly reflective materials are used for surrounding walls or floors, unnecessary reflected light from walls or floors could be overlapped with a measured result, thereby causing a situation as if the optical path length seems longer than actual. Such situation is referred to as multipath phenomenon. Due to this phenomenon, the optical path is measured longer than the actual length, which causes distance errors.

WO2019/188348 describes a method for correcting a distance error which is caused by multipath phenomenon. The distance information acquiring device in this literature estimates, from an actually received optical pulse acquired at a solid imaging element (optical receiver), an ideal pulse shape without multipath. The device then compares those pulses, thereby determining whether a multipath exists to correct the received pulse. Accordingly, this literature attempts to improve the distance accuracy.

### SUMMARY OF THE DISCLOSURE

The correcting method in WO2019/188348 calculates a variation (broken line) of received light amount (accumulated amount) during an exposure period as well as shifting an exposure timing by a predetermined width, compares the calculated variation with a variation (broken line of reference data) of received light amount under an environment without multipath, thereby calculating a correcting coefficient according to a ratio of accumulated amounts between them at a predetermined exposure timing. Therefore, the configuration of device is complicated due to increase in processing load of the correction such as controlling exposure timing or acquiring temporal variation of received light amount, which also increases the device cost. Further, the degree of influence from multipath depends on the measuring environment such as walls or floors. Thus the correcting coefficient is different between different measured distances (i.e. different between short distance measurement and long distance measurement). WO2019/188348 does not specifically consider calculating the correcting coefficient depending on the magnitude of measured distance.

The present disclosure has been made in view of the problems above, and an objective of the present disclosure is to easily and precisely correct a distance error caused by multipath phenomenon in a distance measuring apparatus using TOF method.

A distance measuring apparatus according to the present disclosure identifies an equation of plane that approximates a plane in a space where a target object exists, compares the equation of plane with a measured distance of the place, thereby calculating a correcting value for correcting a measured distance.

With the distance measuring apparatus according to the present disclosure, in a distance measuring apparatus using TOF method, it is possible to significantly reduce processing load for correcting distance errors, and to appropriately correct a measured result according to a magnitude of measured distance.

### BRIEF DESCRIPTION OF THE DRAWINGS

FIG. 1 is a configuration diagram of a distance measuring apparatus 1.

FIG. 2 is a diagram that explains a theory for measuring distance using TOF method.

FIG. 3 is an example of pulse light used for measuring distance.

FIG. 4 is a diagram that explains multipath phenomenon.

FIG. 5A illustrates an example of scene targeted by the distance measuring apparatus 1.

FIG. 5B illustrates an example of scene targeted by the distance measuring apparatus 1.

FIG. 6A illustrates an example of a spot where a distance can be precisely acquired and of a spot where influence from multipath phenomenon is small.

FIG. 6B illustrates an example of a spot where a distance can be precisely acquired and of a spot where influence from multipath phenomenon is small.

FIG. 7 is a diagram that schematically explains a procedure for creating a correction table.

FIG. 8 is a flowchart illustrating a procedure for correcting a distance error by the distance measuring apparatus 1.

FIG. 9 is a graph that explains an effect of embodiment.

### DESCRIPTION OF THE PREFERRED EMBODIMENTS

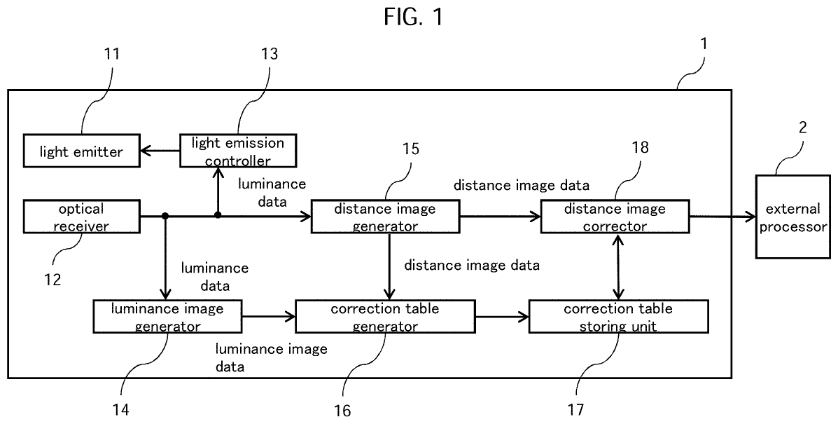

FIG. 1 is a configuration diagram of a distance measuring apparatus 1 according to an embodiment of this disclosure. The distance measuring apparatus 1 is an apparatus that measures a distance to a target object using TOF method. The distance measuring apparatus 1 includes a light emitter 11, an optical receiver 12, a light emission controller 13, a luminance image generator 14, a distance image generator 15, a correction table generator 16 (correcting value generator), a correction table storing unit 17, and a distance image corrector 18.

The light emitter 11 irradiates pulse light to a target object using an optical source such as laser diode (LD) or light emitting diode (LED). The optical receiver 12 receives pulse light reflected from the target object using such as CCD sensor or CMOS sensor. The light emission controller 13 turns on/off the light emitter 11, or controls amount of luminescence of the light emitter 11. The luminance image generator 14 generates, as two-dimensional image data (luminance image data), an optical intensity distribution of subject according to a detection signal (received light data or luminance data) of the optical receiver 12. The distance image generator 15 generates distance image data using the detection signal of the light emitter. The correction table generator 16 generates a correction table from the luminance image and the distance image. Details of the correction table will be described later. The correction table storing unit 17 stores the correction table. The distance image corrector 18 corrects the distance image by the correction table.

The corrected distance data is sent to an external processor 2. The external processor 2 is a computer such as a personal computer. The external processor 2 performs processing to each portion of the target object such as colorization that changes hues according to the distance correction data, thereby generating a distance image (image processing operation), and then displays the distance image on a display (displaying operation). The external processor 2 also analyzes variation of position of the target object (such as persons) according to the distance data, thereby acquiring movement trajectories (flow line) of the target object.

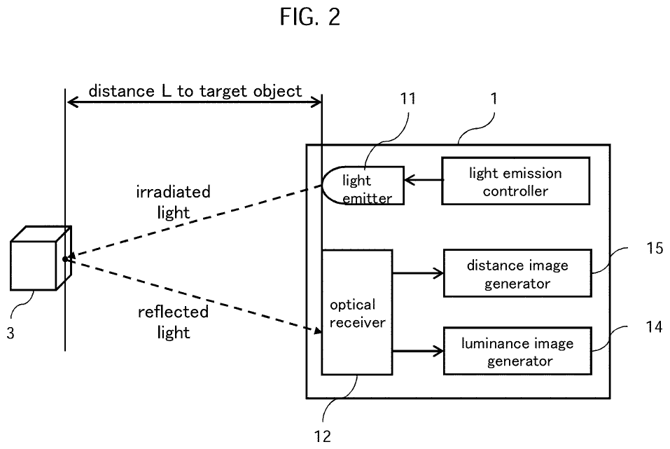

FIG. 2 is a diagram that explains a theory for measuring distance using TOF method. This figure illustrates a relationship between the distance measuring apparatus 1 and the target object 3. The light emitter 11 emits, toward the target object 3, irradiated light for measuring distance. The optical receiver 12 receives reflected light reflected from the target object 3 using a two-dimensional sensor such as CCD. The target object 3 is located at a position separated from the light emitter 11 and from the optical receiver 12 by a distance L. Now it is assumed that speed of light is c, a time difference is t from when the light emitter 11 emits the irradiated light to when the optical receiver 12 receives the reflected light. The distance L to the target object 3 is calculated by L=c×t/2. The distance image generator 15 calculates the distance to the target object 3 according to the equation.

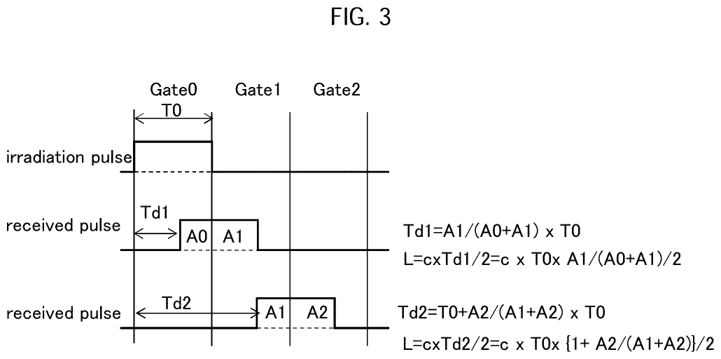

FIG. 3 is an example of pulse light used for measuring distance. In practical distance measurement, a received light amount is used instead of the time difference t as described below. With respect to the irradiation pulse having a predetermined width as shown in FIG. 3, the irradiation pulse is received during multiple exposure gate periods of the two-dimensional sensor. The distance L is calculated according to a value of received light amount (accumulated amount) during each exposure gate period. The equation for calculating L is as below.

When received light amount satisfies A0>A2 (the measured distance is relatively small),

L=c×Td1/2=c×T0×A1/(A0+A1)/2 (Equation 1)

When received light amount satisfies A0<A2 (the measured distance is relatively large),

L=c×Td2/2=c×T0×{1+A2/(A1+A2)}/2 (Equation 2)

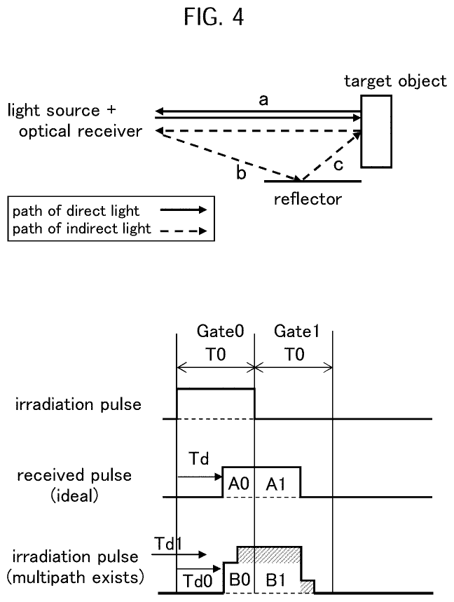

FIG. 4 is a diagram that explains multipath phenomenon. The irradiated light emitted from the light emitter shown in FIG. 4 upper diagram is reflected from the target object and then returns to the optical receiver. Usually the reflected light travels along the solid line, which is a shortest path. The light along this optical path is referred to as “direct light”. On the other hand, under an environment where highly reflective materials are used for walls or floors, a part of the irradiated light is reflected at those walls or floors, and then returns to the optical receiver along the optical path shown with the dotted line. This phenomenon is referred to as “multipath phenomenon”. The light along this optical path is referred to as “indirect light”. In other words, the indirect light does not travel a shortest distance between the light emitter and the target object or between the target object and the optical receiver. Thus the indirect light is observed as being delayed from the direct light.

As shown in the lower diagram in FIG. 4, when multipath phenomenon occurs, the received pulse is observed as mixed light of the direct and the indirect light. This causes an error of measured distance in the distance measuring apparatus 1.

When multipath phenomenon occurs, there exists not only one but a plurality of optical paths for the indirect light in many cases. In addition, the intensity ratio between the direct light and the indirect light varies depending on the case. The direct light is incident on the optical receiver, while a plurality of the indirect light is incident on the optical receiver with a time delay with respect to the direct light. When using exposure gate scheme, the received light amount detected during a predetermined gate period is shifted from the original received light amount (i.e. when no multipath exists). Such shift in the received light amount appears as a distance error when calculating the distance.

Under consideration by this disclosure, it is found that : TOF camera is targeted to specific scenes ; an area having small multipath error can be predicted a priori according to the distance image and the luminance image. Thus this disclosure handles the distance error due to multipath utilizing those facts.

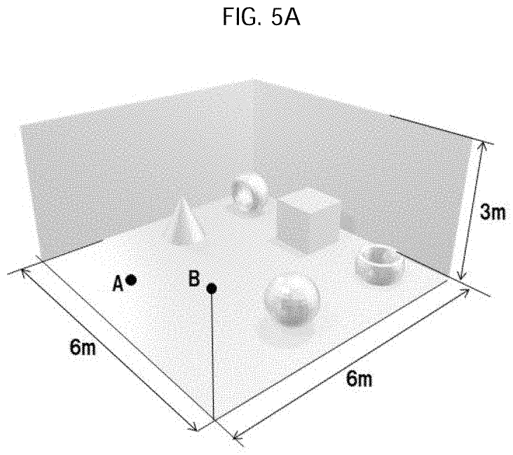

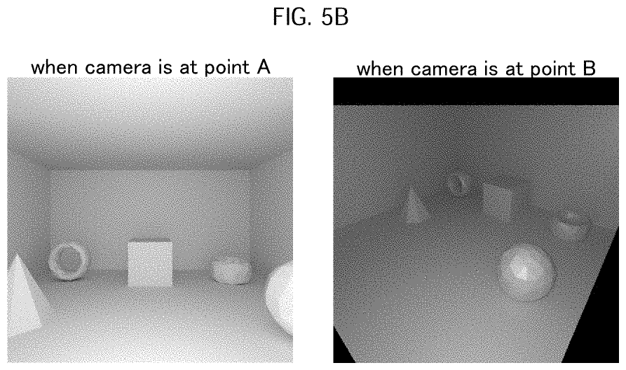

FIGS. 5A-5B illustrate an example of scene targeted by the distance measuring apparatus 1. The TOF camera observes light that is irradiated from a light source and then is returned back. Thus the TOF camera is used only for scenes where ambient light is small and relatively short distance is measured. Namely, most of environments used for the TOF camera are indoor environments. When limited to indoor usage, most of images captured by the TOF camera include background images of walls/ceilings/floors in any case of the camera position. FIGS. 5A-5B are an example of such indoor environment (the cases captured from points A and B both include planes). As described below, it is possible to identify an image area corresponding to these planes existing in a three-dimensional space according to the distance image and the luminance image.

After identifying the plane area in the image, the equation of plane of that plane is identified, thereby it is assumed to be able to correct a distance measurement error by comparing coordinates in the equation of plane with the measured result by the distance measuring apparatus 1. Thus firstly, an area (plane area) that is assumed to be a plane within the image area is distinguished from an area that is assumed to be a target object, and then the equation of that plane is identified.

When a plane in a three-dimensional space is projected onto a two-dimensional image plane, it is not possible to identify the plane in the three-dimensional space only from a condition that it is a plane. Three or more precise positions are necessary to identify the plane. However, due to multipath, such precise positions are not guaranteed. Under consideration by this disclosure, it is found that there exists a point where its distance can be precisely acquired or a point where the influence of multipath is relatively small and thus the distance is precisely acquired. It is assumed that these points can be used to precisely identify planes in the image.

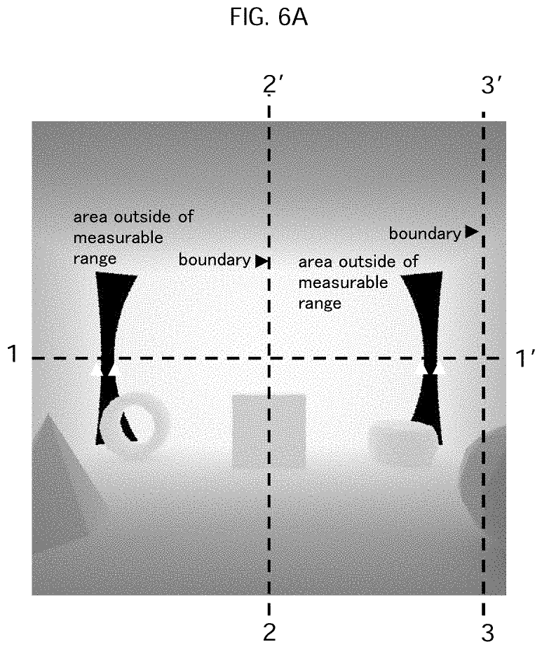

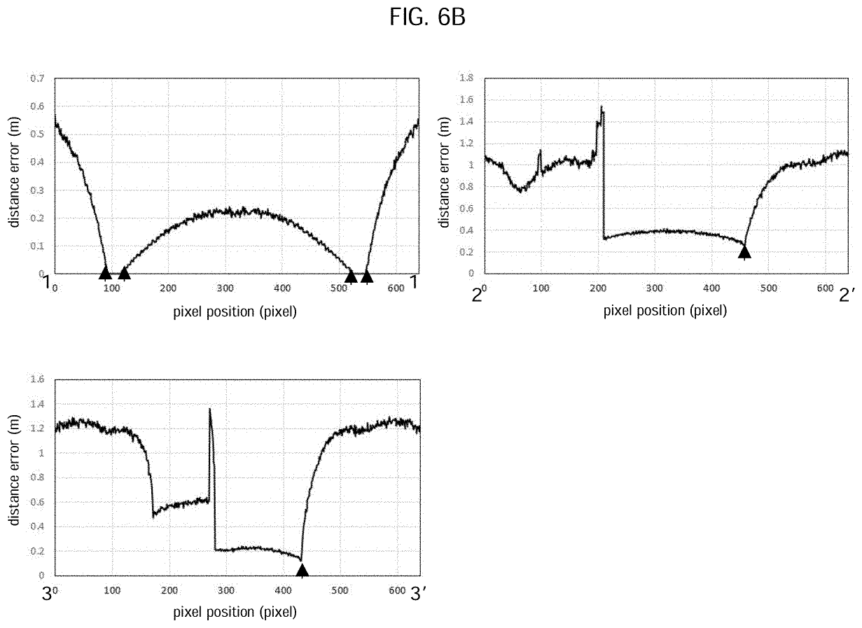

FIGS. 6A-6B illustrate an example of a spot where a distance can be precisely acquired and of a spot where influence from multipath is small. It is considered to be desirable to identify the plane using these points. Hereinafter, it will be described why it is appropriate to use these points as reference points for identifying planes.

The areas sandwiched by two triangles in the 1-1′ cross section (the black-painted area at left back corner of FIG. 6A and the black-painted area at right back corner of FIG. 6A) exist at positions beyond the range which distance is measurable by the distance measuring apparatus 1. At the both ends of this area (i.e. two triangle positions), A1=0 in Equation 2 and thus the equation is always L=c×T0. Accordingly, as shown by the area sandwiched by triangles in the left top graph of FIG. 6B, the distance measurement error is 0. Therefore, at the boundaries of areas outside of the measurable range, this value is always guaranteed.

The boundary (the position indicated by the triangle in the 2-2′ cross section) between the ceiling plane and the sidewall plane in the 2-2′ cross section corresponds to a structurally recessed shape position viewed from the camera. This position has small influence from the indirect light, i.e. from multipath. The distance measurement error at this boundary is minimum in the 2-2′ cross section as shown by the triangle point in the right top graph of FIG. 6B. It is desirable to identify the plane using a measured distance of this point.

Regarding the boundary (the position indicated by the triangle in the 3-3′ cross section) between the ceiling plane and the sidewall plane in the 3-3′ cross section, it is similar to the 2-2′ cross section. The triangle point in the left bottom graph of FIG. 6B shows about it.

FIG. 6A shows examples of boundaries between the ceiling plane and the sidewall plane. Similarly, the distance measurement error is minimum at the boundary between the floor plane and the sidewall plane, and at the boundary between the sidewall planes. The distance measuring apparatus 1 can relatively precisely calculate planes such as ceiling/wall/floor using measured distances of these points.

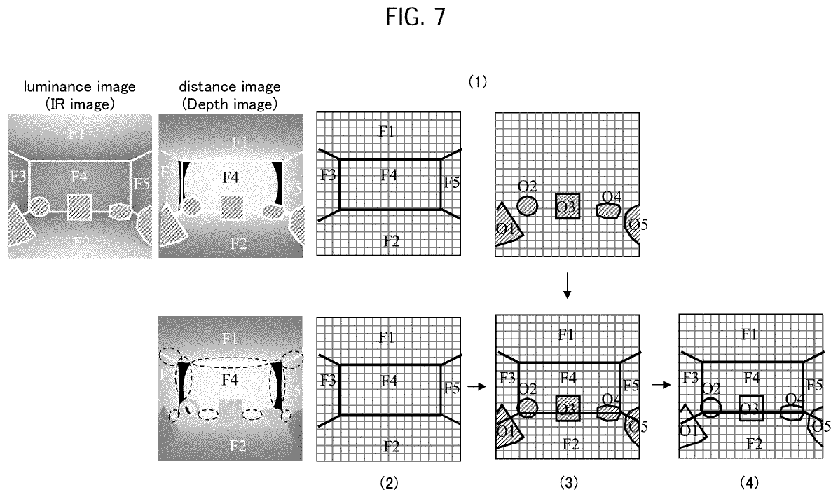

FIG. 7 is a diagram that schematically explains a procedure for creating a correction table. Firstly, areas are extracted which are assumed to be planes such as floor/ceiling/wall according to the acquired luminance image and the distance image. In the example shown in FIG. 7, the plane areas of F1, F2, F3, F4, and F5 correspond to the extracted areas. When doing this operation, other areas are also extracted where non-planar target objects exist (areas of O1, O2, O3, O4, O5). The luminance image and the distance image are both used because the luminance image shows boundaries of wall or ceiling more clearly than the distance image, whereas the distance image provides more precise measurement than the luminance image at non-continuous points of distance between the background and the target object. In some cases, only one of those images may be used (step (1)).

The area which is assumed to be a plane can be provisionally identified by below, for example. An indoor environment image including planes such as sidewall, ceiling plane, or floor plane and plane areas within that image are learned in advance by machine learning. The actually captured image is compared with the learned result by such as pattern matching process. Accordingly, it is possible to provisionally identify plane areas in the captured image. Alternatively, if all of or parts of parameters (e.g. coordinates) of plane areas are known in advance as described later, such parameters may be used to identify the plane areas.

Then in accordance with the procedure described with FIGS. 6A-6B, the positions where the distance error is minimum are extracted from the distance image. The extracted positions are converted into three-dimensional coordinates (X, Y, Z). These coordinates are used to identify the equations of each plane. When there exists four or more points where the distance error is minimum for the plane to be identified, it is desirable to identify the plane by minimizing the error from all points using such as minimum square method (step (2)).

Using the identified equations of plane, correcting values are calculated for each of pixels of the measured distance image. Specifically, the correcting value may be a difference between the coordinate represented by the equation of plane and the actually measured distance corresponding to that coordinate. Accordingly, all measured distance values on a plane represented by a same equation of plane are placed on the same equation of plane. The calculated correcting value is saved as the correction table. The image areas where target objects exist other than the provisionally identified planes are not corrected in this step. Namely the correcting value is 0 (step (3)).

The distance image is corrected using the correction table. In the corrected distance image, the distance values of areas (plane areas) other than the target object are values calculated from the equation of plane, and the distance values of target objects other than plane are as measured. This distance image data is used to generate correction data for target object areas other than plane (step (4)).

Correcting values for areas other than plane may be calculated by such as below. Distance errors are varied for each of measured points even for measured points that are placed by correction on a same equation of plane. Therefore, correcting values for placing measured points onto the same equation of plane are different for each of measured points. Similarly, even for measured points which measured distances are same, the correcting values are different for each of measured points. Thus correcting values are tallied for each of measured points having same measured distance, and then an average of the tallied correcting values is calculated. Accordingly, it is possible to calculate an average correcting value for each of same measured distance value. With respect to a measured distance value of target object area, an average correcting value corresponding to the measured distance value is applied, thereby it is assumed that the measured result of target object area is appropriately corrected. This average correcting value is employed as a correcting value for the target object area.

For example, it is assumed that there exists 100 measured points where the measured distance is 1.00, and that an average of correcting values for those 100 measured points is +0.02. Correcting value of +0.02 is applied to measured points where the measured distance is 1.00 in target object areas. Accordingly, it is possible to identify correcting values for target object areas according to correcting values of plane areas.

It is not always necessary to calculate an average correcting value for strictly same measured distance. An average correcting value may be calculated for a measured distance range which could be deemed as substantially same. In the example above, measured points having measured distances of 0.999 to 1.001 may be deemed as substantially having a measured distance of 1.00, and then an average of correcting values may be calculated for these measured points. In this case, the average correcting value is applied to measured points having measured distance of 0.999 to 1.001 in target object areas.

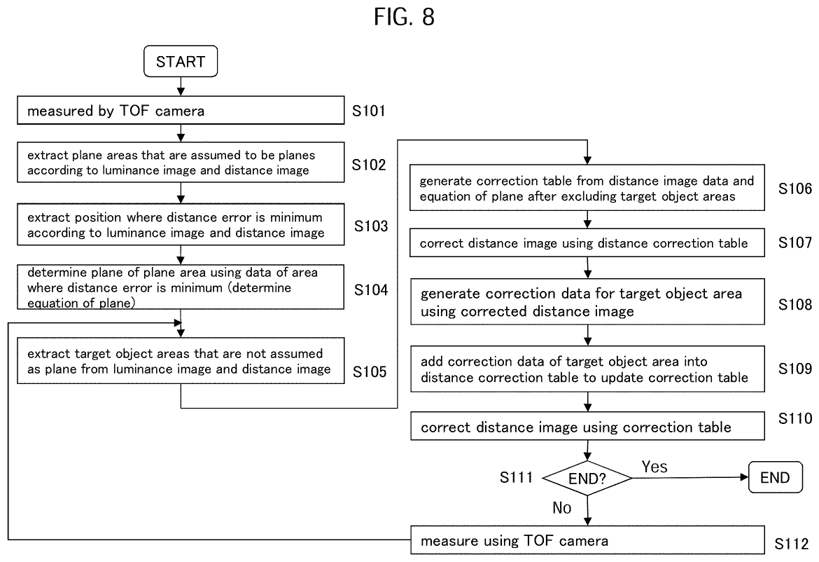

FIG. 8 is a flowchart illustrating a procedure for correcting a distance error by the distance measuring apparatus 1. Hereinafter, each step in FIG. 8 will be described.

S101: The distance measuring apparatus 1 captures an image of scene using TOF method where a target object exists. The luminance image generator 14 generates a luminance image from luminance data of capturing light. The distance image generator 15 generates a distance image.

S102: The correction table generator 16 extracts plane areas that are assumed to be planes such as floor or ceiling according to the luminance image and the distance image acquired in S101. The plane areas extracted in this step are not precisely identified by equation of plane, and thus provisionally classifies areas that are assumed to be planes and areas that are assumed to be target objects. This step corresponds to step (1) in FIG. 7.

S103: The correction table generator 16 extracts positions where the distance error is minimum according to the luminance image and the distance image acquired in S101. The extracting method is as described in FIGS. 6A-6B. For example, in the plane area that is provisionally classified in S102, measured distances are acquired on the cross section described in FIGS. 6A-6B. The inflection point of the measured distance is assumed to be a crossing point between planes. Therefore, the correction table generator 16 estimates the inflection point as a position where the distance error is minimum.

S104: The correction table generator 16 determines an equation of plane of the plane area using the measured position data at the position where the distance error is minimum identified in S103. This step corresponds to step (2) in FIG. 7.

S105: The correction table generator 16 extracts, from the luminance image and the distance image acquired in S101, areas (target object areas) that are not assumed to be planes. The portions acquired by excluding the plane areas from the image may be assumed as target object areas.

S106: The correction table generator 106 generates a correction table from the distance image data and the equation of planes after excluding the target object areas identified in S105. This step corresponds to step (3) in FIG. 7.

S107: The distance image corrector 18 corrects measured distance values of plane areas in the distance image using the correction table generated in S106.

S108: The correction table in S106 is configured only by correcting values for plane areas (not including correcting values for target object areas). The correction table generator 16 calculates correcting values for target object areas using the correcting values for plane areas. This step correspond to step (4) in FIG. 7.

S109: The correction table generator 16 adds the correction data of S108 into the correction table.

S110: The distance image corrector 18 corrects the measured distance values of target object areas in the distance image using the correction table of S109.

S111: This flowchart is terminated if capturing operation of TOF camera is finished or if the background scene significantly changes such as when moving the camera. If the background scene does not significantly change, the correction data for plane areas is not modified, and the measured image is updated in S112 in order to update the correction data only for target object areas that are not assumed as planes. Then the flowchart returns back to S105.

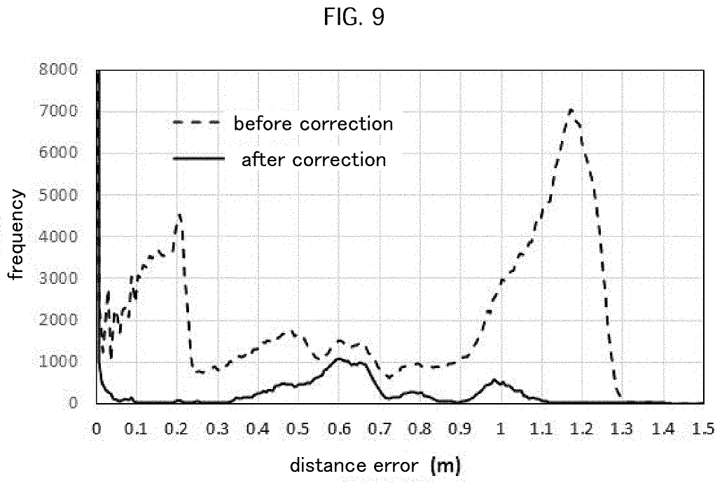

FIG. 9 is a graph that explains an effect of this embodiment. The horizontal axis indicates distance error. The vertical axis indicates frequency. Since most of image area are backgrounds, the total error is significantly improved, thereby significant improvement is expected. In other words, under imaging environments where there are many background portions configured by planes, it is assumed to be possible to precisely correct target object areas by precisely correcting measured distances of such background portions.

### <Summary of Embodiment>

The distance measuring apparatus 1 according to this embodiment: provisionally classifies image areas of space where the target object 3 exists into plane areas and target object areas; identifies equations of plane representing planes of plane areas; compares coordinates on the equations of plane with actually measured distances, thereby calculating correcting values for correcting measured distances. By precisely identifying planes using equations of plane, it is possible to precisely correct measured distance values even when multipath influence occurs.

The distance measuring apparatus 1 according to this embodiment identifies equations of plane of plane areas using a portion as reference where the distance error in the distance image is minimum. Accordingly, it is possible to precisely identify equations of plane. Thereby it is possible to precisely calculate correcting values for distance errors.

The distance measuring apparatus 1 according to this embodiment uses, as a portion where the distance error in the distance image is minimum, at least one of: (a) a boundary point between an area that is farer from the range where the distance is measurable and an area where the distance is measurable; (b) a portion where a ceiling plane intersects with a sidewall plane; (c) a portion where a floor plane intersects with a sidewall plane; (d) a portion where two sidewall planes intersect with each other. It is known that these portions have small error of measured distance. By using these portions as a reference, it is possible to precisely identify equations of plane.

### <Modification of Embodiment>

In the embodiment above, the correction table stores correcting values for each of pixels in distance image. Instead of storing correcting values for each of pixels, it may be considered to use correcting equations that calculate correcting values as a function of pixel coordinates. However, it is not always possible to represent actual errors of measured distance by a single function. In some cases, correcting values could be different from each other depending on the pixel position. In order to precisely correct errors of measured distance under such environments, it is desirable to use a table storing correcting values for each of pixels as described in the embodiment above.

In the embodiment above, equations of plane are identified that represent planes in plane areas. This method can be applied even when the plane in the imaged space is not strictly a plane. For example, even when there are small protrusions and recesses on a wall in a room and thus the wall is not strictly a plane, the equation of plane identified by the embodiment approximates the wall plane. Most of coordinates represented by the equation of plane precisely represent measured distances of the wall. Thus the embodiment above is useful as long as assuming such facts.

In the embodiment above, equations of plane are identified using a reference where measured distance error is minimum. Instead of or along with it, if coordinates of a plane in the imaged space are known, the equation of plane may be identified using those known coordinates. Then it is possible to identify the equation of plane more precisely. Alternatively, the equation of plane may be identified using parameters that are used for identifying equations of plane in the imaged space. Examples of those parameters may include such as: coefficients of equation of plane; parameters representing relative positions between planes (e.g. an angle between planes).

In the embodiment above, the light emitter 11 irradiates pulse light. The embodiment above can be applied to other light-emitting schemes. For example, the embodiment above can be applied to a measuring scheme irradiating continuous light.

In the embodiment above, the light emission controller 13, the luminance image generator 14, the distance image generator 15, the correction table generator 16, and the distance image corrector 18 may be configured by hardware such as circuit device implementing functions of them, or may be configured by software (distance measuring program) implementing functions of them being executed by processors such as CPU (Central Processing Unit).

### DESCRIPTION OF SYMBOLS

1: distance measuring apparatus
11: light emitter
12: optical receiver
13: light emission controller
14: luminance image generator
15: distance image generator
16: correction table generator 16
17: correction table storing unit
18: distance image corrector

What is claimed is:

1. A distance measuring apparatus that measures a distance to a target object, comprising:
a light emitter that irradiates light to the target object;
an optical receiver that receives light reflected from the target object;
a luminance image generator that generates, using an intensity of the light received by the optical receiver, a luminance image of a space which includes the target object;
a distance image generator that generates a distance image of the space using an intensity of the light received by the optical receiver;
a correcting value generator that calculates a correcting value for the distance image using the luminance image and the distance image; and
a distance image corrector that corrects the distance image using the correcting value,
wherein the correcting value generator provisionally classifies, using the luminance image and the distance image, an image area of the space into a target object area configured by an image of the target object and a plane area configured by an image of a plane included in the space,
wherein the correcting value generator calculates an equation of plane that approximates the plane of the plane area, and
wherein the correcting value generator compares the equation of plane with a measured distance value of the distance image in the plane area, thereby calculating the correcting value for correcting a measured distance value of the distance image in the target object area.

2. The distance measuring apparatus according to claim 1,
wherein the correcting value generator identifies a minimum error portion where a distance error of measured distance value in the distance image is minimum, and
wherein the correcting value generator calculates the equation of plane using a coordinate of the minimum error portion.

3. The distance measuring apparatus according to claim 2,
wherein the minimum error portion is at least one of:
a boundary point between an area exceeding a distance range which distance is measurable by the distance measuring apparatus and an area which distance is measurable by the distance measuring apparatus;
a portion where a ceiling plane in the space intersects with a sidewall plane in the space;
a portion where a floor plane in the space intersects with a sidewall plane in the space; or
a portion where two sidewall planes in the space intersect with each other.

4. The distance measuring apparatus according to claim 1,
wherein the correcting value generator calculates the correcting value so that the measured distance values belonging to a same one of the equation of plane are placed on a plane represented by the same one of the equation of plane.

5. The distance measuring apparatus according to claim 4,
wherein the correcting value generator calculates an average of the correcting values for the measured distance values that can be deemed as a same value in the plane area for each of the measured distance values that can be deemed as the same value, and
wherein the correcting value generator calculates the correcting value for the measured distance value in the target object area using the average calculated for each of the measured distance values that can be deemed as the same value.

6. The distance measuring apparatus according to claim 5,
wherein the correcting value generator calculates the correcting value using the same one of the equation of plane only for the plane area within the space, and
wherein after calculating the correcting value only for the plane area, the correcting value generator calculates the correcting value for the target object area using the average calculated for each of the measured distance values that can be deemed as the same value.

7. The distance measuring apparatus according to claim 1,
wherein the correcting value generator calculates the correcting value for each of pixels in the image area.

8. The distance measuring apparatus according to claim 1,
wherein the correcting value generator acquires, in advance, a parameter that represents a known coordinate of the plane of the plane area or that identifies the equation of plane, and
wherein the correcting value generator calculates the equation of plane using the known coordinate or using the parameter.

9. The distance measuring apparatus according to claim 1,
wherein the correcting value generator identifies the equation of plane using the measured distance value for three or more points in the plane area.

10. A distance measuring program that causes a computer to perform a process measuring a distance to a target object, the program causing the computer to perform:
generating, using an intensity of light reflected from the target object, a luminance image of a space which includes the target object;
generating a distance image of the space using an intensity of the light reflected from the target object;
calculating a correcting value for the distance image using the luminance image and the distance image; and
correcting the distance image using the correcting value,
wherein generating the correcting value includes causing the computer to perform provisionally classifying, using the luminance image and the distance image, an image area of the space into a target object area configured by an image of the target object and a plane area configured by an image of a plane included in the space,
wherein generating the correcting value includes causing the computer to perform calculating an equation of plane that approximates the plane of the plane area, and
wherein generating the correcting value includes causing the computer to perform comparing the equation of plane with a measured distance value of the distance image in the plane area, thereby calculating the correcting value for correcting a measured distance value of the distance image in the target object area.
